(19) United States
(12) Patent Application Publication
(10) Pub. No.: US 2020/0006009 A1
(43) Pub. Date: Jan. 2, 2020

(54) ELECTRICITY STORAGE DEVICE AND METHOD FOR MANUFACTURING SOLID ELECTROLYTE LAYER

(71) Applicant: Kabushiki Kaisha Nihon Micronics, Tokyo (JP)

(72) Inventors: Takashi TONOKAWA, Aomori (JP); Kazuyuki TSUNOKUNI, Aomori (JP); Juri OGASAWARA, Aomori (JP); Yuki SATO, Aomori (JP)

(21) Appl. No.: 16/569,329

(22) Filed: Sep. 12, 2019

Related U.S. Application Data
(63) Continuation of application No. PCT/JP2018/007774, filed on Mar. 1, 2018.

(30) Foreign Application Priority Data
Mar. 15, 2017 (JP) 2017-049589

(51) Int. Cl. H01G 9/025; H01G 9/00; H01G 4/10

(52) U.S. Cl. CPC H01G 9/025; H01G 4/10; H01G 9/0036

(57) ABSTRACT

The electricity storage device includes: a first conductivity-type first oxide semiconductor; a solid electrolyte layer disposed on the first oxide semiconductor layer, the solid electrolyte layer including a solid electrolyte enabling proton movement; an insulator layer disposed between the solid electrolyte layer and the first oxide semiconductor layer, the insulator layer including an insulating material; and a second conductivity-type second oxide semiconductor layer disposed on the solid electrolyte layer. Provided is the electricity storage device having the increased electricity storage capacity and improved reliability that can be charged without degradation even when the charging voltage is increased.

### CROSS-REFERENCE TO RELATED APPLICATIONS

This application is a continuation of international patent application number PCT/JP2018/007774, having an international filing date of Mar. 1, 2018, which claims priority to Japan patent application number P2017-049589, filed on Mar. 15, 2017. The entire content of the referenced applications is incorporated herein by reference.

### TECHNICAL FIELD

The embodiments described herein relate to an electricity storage device and a method for manufacturing a solid electrolyte layer.

### BACKGROUND

Capacitors have been generally used as a structure in which an insulation layer is sandwiched between electrodes from both sides.

Moreover, there has also been proposed an electricity storage device having a structure in which an n type semiconductor layer, a hydrous porous insulation layer, and a p type semiconductor layer are layered one after another, and electrodes are formed on upper and lower sides thereof.

### BRIEF SUMMARY

The embodiments provide an electricity storage device having an increased electricity storage capacity and improved reliability that can be charged without degradation even when a charging voltage is increased, and a method for manufacturing a solid electrolyte layer.

According to one aspect of the embodiments, there is provided an electricity storage device comprising: a first conductivity-type first oxide semiconductor; a solid electrolyte layer disposed on the first oxide semiconductor layer, the solid electrolyte layer including a solid electrolyte enabling proton movement; and a second conductivity-type second oxide semiconductor layer disposed on the solid electrolyte layer.

According to another aspect of the embodiments, there is provided a method for manufacturing a solid electrolyte layer comprising: coating diluted silicone oil; firing the coated silicone oil; and irradiating the fired silicone oil with ultraviolet rays.

According to the embodiments, there can be provided the electricity storage device having the increased electricity storage capacity and improved reliability that can be charged without degradation even when the charging voltage is increased, and the method for manufacturing the solid electrolyte layer.

### BRIEF DESCRIPTION OF THE DRAWINGS

FIG. 1A is a schematic cross-sectional structure diagram showing an electricity storage device according to a comparative example 1.

FIG. 1B is a charging and discharging characteristic diagram of the electricity storage device according to the comparative example 1.

FIG. 2A is a schematic cross-sectional structure diagram showing an electricity storage device according to a comparative example 2.

FIG. 2B is a charging and discharging characteristic diagram of the electricity storage device according to the comparative example 2.

FIG. 3A is a schematic cross-sectional structure diagram showing an electricity storage device according to the embodiments.

FIG. 3B is a charging and discharging characteristic diagram of the electricity storage device according to the embodiments.

### DETAILED DESCRIPTION

Next, the embodiments will be described with reference to drawings. In the description of the following drawings, the identical or similar reference sign is attached to the identical or similar part. However, it should be noted that the drawings are schematic and therefore the relation between thickness and the plane size and the ratio of the thickness differs from an actual thing. Therefore, detailed thickness and size should be determined in consideration of the following explanation. Of course, the part from which the relation and ratio of a mutual size differ also in mutually drawings is included.

Moreover, the embodiments shown hereinafter exemplify the apparatus and method for materializing the technical idea; and the embodiments do not specify the material, shape, structure, placement, etc. of each component part as the following. The embodiments may be changed without departing from the spirit or scope of claims.

In explanation of following embodiments, a first conductivity type means an n type and a second conductivity type means a p type opposite to the first conductivity type, for example.

### Comparative Example 1

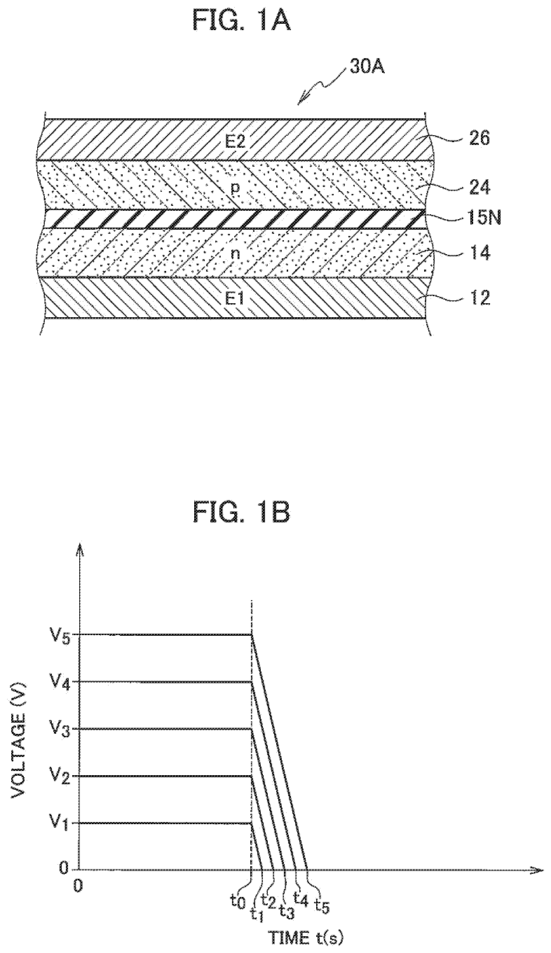

FIG. 1A shows a schematic cross-sectional structure showing an electricity storage device 30A according to the comparative example 1, and FIG. 1B schematically shows charging and discharging characteristics thereof.

As shown in FIG. 1A, the electricity storage device 30A according to the comparative example 1 includes, between the first electrode (E1) 12 and the second electrode (E2) 26, a first oxide semiconductor layer 14, an insulator layer 15N disposed on the first oxide semiconductor layer 14, and a second oxide semiconductor layer 24 disposed on the insulator layer 15N.

The insulator layer 15N can be formed by including SiN_{y}, for example.

The second oxide semiconductor layer 24 can be formed by including a nickel oxide (NiO) which is a p type oxide semiconductor.

As shown in FIG. 1B, for example, in the charging and discharging characteristics of the electricity storage device according to the comparative example 1, with respect to voltages V (V₁ to V₅) at the time of charging, the voltage V₁ is changed to 0V at time t₁ after time t₀, the voltage V₂ is changed to 0V at time t₂, the voltage V₃ is changed to 0V at time t₃, the voltage V₄ is changed to 0V at time t₄, and the voltage V₅ is changed to 0V at time t₅; and then the respective voltages are shifted to a discharged state. More specifically, the charging and discharging characteristics shown in FIG. 1B correspond to the charging and discharging characteristics of the capacitor. The discharging characteristics of the electricity storage device according to the comparative example 1 indicate linear characteristics, as shown in FIG. 1B.

According to the electricity storage device according to the comparative example 1, the capacitor is merely formed if only providing the insulator layer 15N and therefore an amount of electricity storage is also small.

### Comparative Example 2

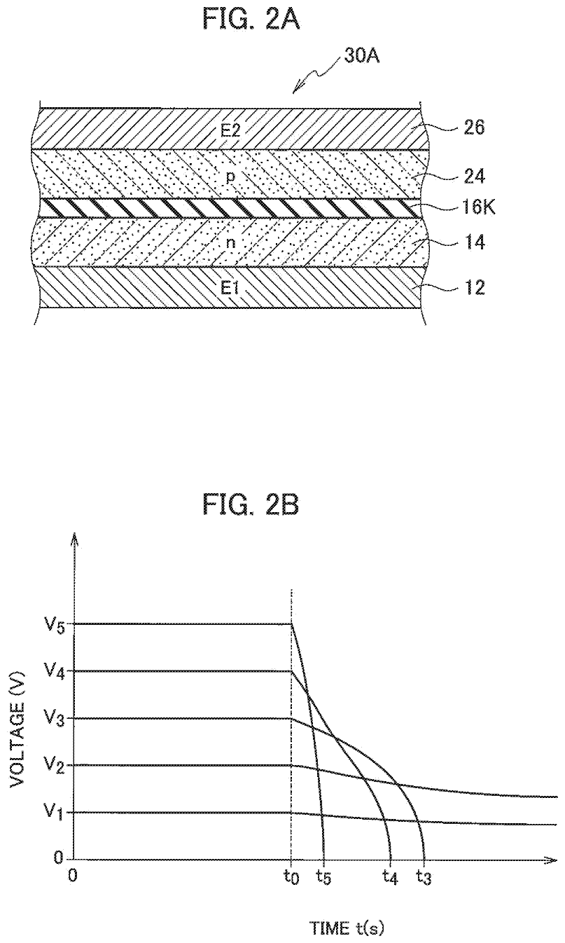

FIG. 2A shows a schematic cross-sectional structure showing an electricity storage device 30A according to the comparative example 2, and FIG. 2B schematically shows charging and discharging characteristics thereof.

As shown in FIG. 2A, the electricity storage device 30A according to the comparative example 2 includes, between the first electrode (E1) 12 and the second electrode (E2) 26, a first oxide semiconductor layer 14, a solid electrolyte layer 16K which is disposed on the first oxide semiconductor layer 14 and has a solid electrolyte enabling proton movement, and a second oxide semiconductor layer 24 disposed on the solid electrolyte layer 16K.

The solid electrolyte layer 16K can be formed by including a silicon oxide (SiOₓ), for example. Other configurations thereof are the same as those of the comparative example 1.

As shown in FIG. 2B, for example, in the charging and discharging characteristics of the electricity storage device according to the comparative example 2, with respect to voltages V (V₁ to V₅) at the time of charging, the voltage V₃ is changed to 0V at time t₃ after time t₀, the voltage V₄ is changed to 0V at time t₄, and the voltage V₅ is changed to 0V at time t₅; and then the respective voltages are shifted to a discharged state. The discharging characteristics of the electricity storage device according to the comparative example 2 indicate decreasing characteristics, as shown in FIG. 2B.

According to the charging and discharging characteristics of the electricity storage device according to the comparative example 2, an amount of electricity storage larger than the electricity storage device according to the comparative example 1 is obtained even when charging for a long period in a constant current.

The electricity storage device 30A according to the comparative example 1 has small amount of electricity storage since it indicates the capacitor characteristics. However, since the electricity storage device 30A according to the comparative example 2 has a structure in which the solid electrolyte layer 16K contacts the second oxide semiconductor layer 24, as compared with the electricity storage device 30A according to the comparative example 1, it becomes easy to move protons toward the first oxide semiconductor layer 14 from the second oxide semiconductor layer 24 in a voltage applied state in which the second electrode (E2) 26 has high potential with respect to the first electrode (E1) 12. Accordingly, the electricity storage device 30A according to the comparative example 2 can store electricity more than the electricity storage device 30A of the comparative example 1.

Since the electricity storage device 30A according to the comparative example 1 has a structure in which the insulator layer 15N is in contact with the second oxide semiconductor layer 24, it is considered that the proton movement from the second oxide semiconductor layer 24 is interfered by the insulator layer 15N, and therefore movement toward the first oxide semiconductor layer 14 becomes difficult.

However, as shown in FIG. 2B, in the electricity storage device 30A according to the comparative example 2, since it becomes impossible for the solid electrolyte layer 16K to resist the voltage when the voltage V at the time of charging becomes equal to or greater than V₃ (e.g., approximately 3.0V) also in a leak test, the amount of electricity storage is remarkably reduced.

### Embodiments

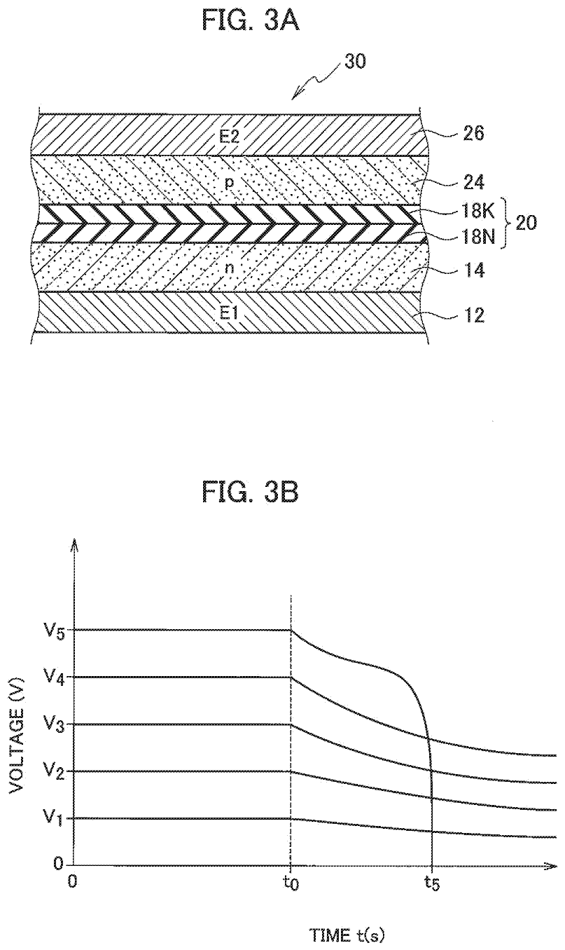

FIG. 3A shows a schematic cross-sectional structure of an electricity storage device 30 according to the embodiments, and FIG. 3B schematically shows charging and discharging characteristics thereof.

As shown in FIG. 3A, the electricity storage device 30 according to the embodiments includes, between the first electrode (E1) 12 and the second electrode (E2) 26, a first oxide semiconductor layer 14, a solid electrolyte layer 18K which is disposed on the first oxide semiconductor layer 14 and has a solid electrolyte enabling proton movement, and a second conductivity-type second oxide semiconductor layer 24 disposed on the solid electrolyte layer 18K.

In the embodiments, the first conductivity-type first oxide semiconductor 14 means an oxide semiconductor layer composed by including a first conductivity-type first oxide semiconductor. The second conductivity-type second oxide semiconductor layer 24 means an oxide semiconductor layer composed by including a second conductivity-type second oxide semiconductor. The same applies hereafter.

Moreover, an insulator layer 18N including an insulating material may be disposed between the solid electrolyte layer 18K and the first oxide semiconductor layer 14.

Moreover, an insulating material may further be contained in the solid electrolyte layer 18K. In the embodiments, a solid electrolyte composed of SiO and an insulating material composed of the SiN, for example, may be contained in the solid electrolyte layer 18K.

Moreover, more solid electrolyte than the insulating material may exist at the second oxide semiconductor layer 24 side of the solid electrolyte layer 18K. More specifically, more solid electrolyte composed of SiO than the insulating material composed of SiN may exist at the second oxide semiconductor layer 24 side of the solid electrolyte layer 18K, for example.

Since the insulator layer 18N is in contact with the solid electrolyte layer 18K in the electricity storage device 30 according to the embodiments, as compared with the electricity storage device 30A according to the comparative example 2, the breakdown voltage is increased.

The solid electrolyte layer 16K can be formed by including SiOₓ, for example. The insulator layer 18N includes plasma-silicon nitride (P-SiN_{y}) (second insulating material) which has a non-hydrous property (no water content) and is not porous, for example. The insulator layer 18N includes a layer with high film density, and has a property that it is hard to contain water as compared with SiOₓ.

A thickness of the SiOₓ is approximately 20 nm to approximately 70 nm, for example.

The insulator layer 18N can be formed by including SiN_{y}, for example. In the embodiments, when the plasma-silicon nitride (P-SiN_{y}) is formed as the SiN_{y}, a thickness thereof is equal to or less than approximately 10 nm, for example. The thickness thereof is more preferably approximately 7 nm to approximately 10 nm, for example.

The first electrode 12 can be formed of a stacked layer of W and Ti or chromium (Cr), and the second electrode 26 can be formed of Al, for example. The first electrode 12 is disposed on a surface which is not opposite to the insulator layer 18N of the first oxide semiconductor layer 14. Moreover, the second electrode 26 is disposed on a surface which is not opposite to the solid electrolyte layer 18K of the second oxide semiconductor layer 24.

The first oxide semiconductor layer 14 can be formed by including a titanium oxide (TiO₂) which is an n type oxide semiconductor, for example.

The second oxide semiconductor layer 24 can be formed by including a nickel oxide (NiO) which is a p type oxide semiconductor. A thickness of the nickel oxide (NiO) is approximately 200 nm, for example.

As shown in FIG. 3B, in the charging and discharging characteristics of the electricity storage device according to the embodiments, with respect to voltages V (V₁ to V₅) at the time of charging, the voltage V₅ is changed to 0V at time is after time t₀, and then the voltage V₅ is shifted to a discharged state.

In the case of the electricity storage device 30 according to the embodiments, as shown in FIG. 3B, for example, reduction of the amount of electricity storage due to degradation of the solid electrolyte layer 18K is observed only after the voltage V at the time of charging becomes equal to or greater than V₅ (e.g., approximately 5.0V). In the case of the electricity storage device 30 according to the embodiments, reduction corresponding to the reduction observed in the case of the single layer silicon oxide (SiOₓ) in the electricity storage device 30A according to the comparative example 2 is observed at 5V.

As shown in FIG. 3B, the discharging characteristics of the electricity storage device 30 according to the embodiments show substantially flat characteristics to the voltages V (V₁ to V₄) at the time of charging, and show the characteristics that the discharging time decreases only after the voltage V at the time of charging becomes equal to or greater than V₅ (e.g., approximately 5.0V) (In the comparative example 2, the discharging time decreases also when the voltage V at the time of charging is 3V).

According to the electricity storage device 30 according to the embodiments, a larger amount of electricity storage than the electricity storage device according to the comparative example 1 or 2 can be confirmed, also in the case of charging for a long period at the constant current.

According to the electricity storage device 30 according to the embodiments, also in the double layered structure of SiN_{y}/SiOₓ into which the insulator layer 18N is inserted, the increased amount of electricity storage more than the capacitor, and the breakdown voltage at the time of charging can also be improved. A larger amount of the electricity storage than the capacitor also in the charging for a long period at the constant current is confirmed. This is a result of reducing degradation of SiOₓ due to the voltage by using the double layered structure.

Moreover, since the breakdown voltage of the film of SiN_{y} is high, the breakdown voltage is improved by using the double layered structure of SiN_{y}/SiOₓ into which the insulator layer 18N inserted, and the breakdown voltage of whole of the electricity storage device 30 can be improved.

Moreover, SiOₓ can be formed from silicone oil.

Moreover, SiOₓ may be formed from a metal containing silicone.

The solid electrolyte layer 18K may be manufactured by a process including: coating diluted silicone oil on a first oxide semiconductor layer 14; firing the coated silicone oil; and irradiating the fired silicone oil with ultraviolet rays.

Moreover, a manufacturing method of the above-mentioned solid electrolyte layer 18K may include: coating diluted silicone oil; firing the coated silicone oil; and irradiating the fired silicone oil with ultraviolet rays.

According to the embodiments, there can be provided the electricity storage device having the increased electricity storage capacity and improved reliability that can be charged without degradation even when the charging voltage is increased.

### Other Embodiments

As explained above, the embodiments have been described, as a disclosure including associated description and drawings to be construed as illustrative, not restrictive. This disclosure makes clear a variety of alternative embodiments, working examples, and operational techniques for those skilled in the art.

Such being the case, the embodiments cover a variety of embodiments, whether described or not.

### INDUSTRIAL APPLICABILITY

The electricity storage device of the embodiments can be utilized for various consumer equipment and industrial equipment, and can be applied to wide applicable fields, such as electricity storage devices for system applications capable of transmitting various kinds of sensor information with low power consumption, e.g. communication terminals and electricity storage devices for wireless sensor networks.

What is claimed is:

1. An electricity storage device comprising:
a first conductivity-type first oxide semiconductor;
a solid electrolyte layer disposed on the first oxide semiconductor layer, the solid electrolyte layer including a solid electrolyte enabling proton movement; and
a second conductivity-type second oxide semiconductor layer disposed on the solid electrolyte layer.

2. The electricity storage device according to claim 1, further comprising an insulator layer disposed between the solid electrolyte layer and the first oxide semiconductor layer.

3. The electricity storage device according to claim 1, further comprising an insulating material contained in the solid electrolyte layer.

4. The electricity storage device according to claim 3, wherein more solid electrolytes than the insulating material exist in the second oxide semiconductor layer side of the solid electrolyte layer.

5. The electricity storage device according to claim 1, wherein the solid electrolyte layer contains SiOₓ.

6. The electricity storage device according to claim 2, wherein the insulator layer contains SiN_{y}.

7. The electricity storage device according to claim 2, wherein a thickness of the insulator layer is equal to or less than 10 nm.

8. The electricity storage device according to claim 2, wherein the insulator layer comprises plasma-SiN_{y} having a non-hydrous property, the plasma-SiN_{y} being not porous.

9. The electricity storage device according to claim 1, wherein the first oxide semiconductor layer contains TiO₂.

10. The electricity storage device according to claim 1, wherein the second oxide semiconductor layer contains NiO.

11. The electricity storage device according to claim 2, further comprising:
a first electrode disposed on a surface which is not opposite to the insulator layer of the first oxide semiconductor layer; and
a second electrode disposed on a surface which is not opposite to the solid electrolyte layer of the second oxide semiconductor layer.

12. The electricity storage device according to claim 5, wherein the SiOₓ is formed from silicone oil.

13. The electricity storage device according to claim 5, wherein the SiOₓ is formed from a metal containing silicone.

14. The electricity storage device according to claim 1, wherein the solid electrolyte layer is manufactured by a process comprising:
coating diluted silicone oil on a first oxide semiconductor layer;
firing the coated silicone oil; and
irradiating the fired silicone oil with ultraviolet rays.

15. A method for manufacturing a solid electrolyte layer, comprising:
coating diluted silicone oil;
firing the coated silicone oil; and
irradiating the fired silicone oil with ultraviolet rays.
